(19) United States
(12) Patent Application Publication
(10) Pub. No.: US 2005/0096916 A1
(43) Pub. Date: May 5, 2005

(54) Recording device and recording method

(75) Inventors: Shojiro Sato, Kawasaki-shi (JP); Yuji Ito, Osato-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/976,363

(22) Filed: Oct. 29, 2004

(30) Foreign Application Priority Data
Oct. 30, 2003 (JP) 2003-371093

(51) Int. Cl. G10L 11/00

(52) U.S. Cl. 704/278

(57) ABSTRACT

A soundless period detection unit detects a soundless period of a program, when a target program is recorded in a recording medium by a timer recording unit. A division information setting unit sets division information into the soundless period. The division information setting unit sets the division information in the soundless period detected by the soundless period detection unit after elapse of a defined time from a time when the division information has been set.

### CROSS-REFERENCE TO RELATED APPLICATIONS

This application is based upon and claims the benefit of priority from the prior Japanese Patent Application No. 2003-371093, filed Oct. 30, 2003, the entire contents of which are incorporated herein by reference.

### BACKGROUND OF THE INVENTION

1. Field of the Invention

The present invention relates to an edition recording device and an edition recording method in which division information such as a chapter is set in a program comprising video information, audio information and the like.

2. Description of the Related Art

As well known, in recent years, a recordable optical disk such as a digital versatile disk (DVD)-RAM (storage capacity of 4.7 GB) which is a medium capable of rewriting data such as video and audio, and an optical disk drive which records/reproduces information with respect to the optical disks have started spreading. In DVD-RAM drives which are optical disk drives, a drive on which a hard disk drive of a 100 GB class is mounted has appeared. A broadcasting signal can be recorded in the DVD-RAM or a hard disk in real time based on standards of real time recording (RTR)-DVD.

Mediums such as a DVD and a hard disk have large storage capacities, and a large number of programs (titles) or a long-time program can be recorded in these mediums. It is considered that a user desires to set divisions in the program in a case where the long-time program is recorded. When the divisions are set in the program, the program is divided into a plurality of chapters. When skip reproduction (jump to the next chapter) is performed during reproduction, a desired scene can be found in a short time, and the program can be seen/heard.

To meet this demands, a technique concerning a recording/reproducing device provided with a chapter preparation guide function has been laid open as in Jpn. Pat. Appln. KOKAI Publication No. 2002-152666 in which the divisions are set while confirming the scene on a screen, and accordingly the chapters can be easily prepared.

In the technique described in the Jpn. Pat. Appln. KOKAI Publication No. 2002-152666, there is a problem that the chapters have to be set while reproducing a timer recorded program and confirming the scene on the screen. That is, to skip/reproduce the timer recorded program, the skip reproduction cannot be performed unless the chapter is set by the user in advance.

### BRIEF SUMMARY OF THE INVENTION

A recording device according to one embodiment of the present invention comprises: a recording unit configured to record a target program in a recording medium; a detection unit configured to detect a soundless period of the program, when the program is recorded in the recording medium by the recording unit; a first setting unit configured to set division information in the soundless period detected by the detection unit in the program to be recorded in the recording medium; a judgment unit configured to judge whether or not a defined time has elapsed from a time when the first setting unit has set the division information; and a second setting unit configured to set the division information in the soundless period detected by the detection unit in the program to be recorded in the recording medium after the elapse of the defined time.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic constitution of an information recording/reproducing device (edition recording device) to which an embodiment of the present invention is applied;

FIG. 2 is a diagram showing a data file constitution of data on a recording medium;

FIG. 3 is a flowchart showing a division information setting operation based on a division information setting condition 1;

FIG. 4 is a timing chart showing the division information setting operation based on the division information setting condition 1;

FIG. 5 is a flowchart showing the division information setting operation based on a division information setting condition 2;

FIG. 6 is a timing chart showing the division information setting operation based on the division information setting condition 2;

FIG. 7 is a diagram showing another program having a constitution of the program to be recorded, which is different from that of FIG. 6;

FIG. 8 is a flowchart showing the division information setting operation based on a division information setting condition 3;

FIG. 9 is a timing chart showing the division information setting operation based on the division information setting condition 3;

FIG. 10 is a diagram showing a modification of an embodiment shown in FIG. 9;

FIG. 11 is a flowchart showing an operation of another embodiment of the present invention; and

FIG. 12 is a diagram showing a data file constitution according to an embodiment shown in FIG. 11.

### DETAILED DESCRIPTION OF THE INVENTION

Embodiments of the present invention will be described hereinafter with reference to the drawings.

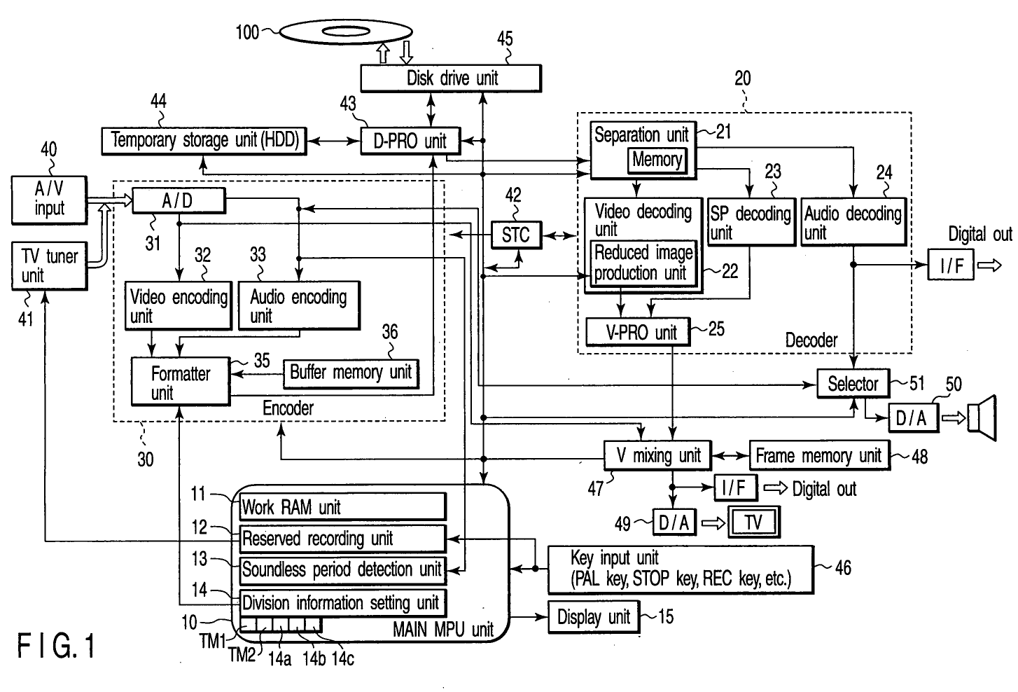

FIG. 1 is a block diagram showing a schematic constitution of an information recording/reproducing device (edition recording device) to which an embodiment of the present invention is applied. The information recording/reproducing device shown in FIG. 1 records video information such as a program into a DVD or a hard disk, and reproduces the recorded information. Here, the program refers to one broadcasted program such as drama, movie, and sport program.

As shown in FIG. 1, the information recording/reproducing device comprises: an MPU unit 10; a display unit 15; a decoder 20; an encoder 30; an A/V input unit 40; a TV tuner unit 41; a system time counter (STC) unit 42; a data processor (D-PRO) unit 43; a temporary storage unit (hereinafter referred to as a hard disk drive (HDD)) 44; a disk drive 45; a key input unit 46; a video (V) mixing unit 47; a frame memory unit 48; a TV D/A unit 49; an audio D/A unit 50; a selector unit 51 and the like.

The MPU unit 10 comprises: a work RAM unit 11; a timer recording unit 12; a soundless period detection unit 13; and a division information setting unit 14. The timer recording unit 12 records a target program based on timer recording information input from the key input unit 46. The soundless period detection unit 13 detects a soundless period from the target program (program to be recorded) based on a soundless period detection condition. The division information setting unit 14 sets division information concerning the soundless period of the target program based on a division information setting condition.

The encoder 30 comprises: an A/D unit 31; a video encoding unit 32; an audio encoding unit 33; a formatter unit 35; a buffer memory unit 36 and the like. The decoder 20 comprises: a separation unit 21; a video decoding unit 22; an SP decoding unit 23; an audio decoding unit 24; a video processor (V-PRO) unit 25 and the like.

The recording is performed using the HDD 44 or the disk drive 45. For example, the HDD 44 records the same data as that recorded in an optical disk 100 such as a DVD-RAM or a DVD-RW by the disk drive 45, and realizes a special process (time shift, write error process, etc.) which is difficult by the disk drive 45 (disk) alone. The HDD 44 has a storage capacity, for example, of about 100 GB. The HDD 44 having a large capacity is used in recording long-time video, and the DVD-RAM is used for video requiring long-term storage. By combination of the HDD 44 with the DVD-RAM which is a recording target of the disk drive 45 in this manner, the video can be recorded utilizing both advantages.

Next, a flow of a video signal will be described. When signals input via the A/V input unit 40 or the TV tuner unit 41 are analog signals, the input signals are converted into digital signals by the A/D unit 31. In the input signals converted by the A/D unit 31, the video signal is input into the video encoding unit 32, and the audio signal is input into the audio encoding unit 33. When the signals input via the A/V input unit 40 or the TV tuner unit 41 are digital signals, in the input signals, the video signal is directly input into the video encoding unit 32, and the audio signal is directly input into the audio encoding unit 33. The video signal is MPEG-compressed by the encoding unit 32, and the audio signal is subjected to AC3 compression or MPEG audio compression by the audio encoding unit 33.

Data formed into packets are provided from the video encoding unit 32 and the audio encoding unit 33, and input into the formatter unit 35. The formatter unit 35 adds a pack header to each input packet to form the packets into a 2048-bytes pack, and the packed data is multiplexed and supplied to the D-PRO unit 43.

The D-PRO unit 43 doubly applies an error correction code, for example, every 16 packs, and forms an error correction code (ECC) block. The ECC block produced by the D-PRO unit 43 is recorded in the disk drive 45 and/or the HDD 44.

In the information recording/reproducing device, continuous sectors are required at minimum in order to continue reproduction without being interrupted during accessing (seeking) in a case where data recorded in the DVD is accessed. This unit is referred to as a continuous data array (CDA). The CDA advantageously has an ECC block unit. In a file system, the recording is performed by this CDA unit.

Next, edition recording by the information recording/reproducing device will be described. Here, for example, a case will be described where the chapter is automatically set in the program to be subjected to the timer recording.

First, the timer recording will be briefly described. Timer recording information required for the timer recording is input via the key input unit 46. Examples of the timer recording information include a channel number, a recording start time, a recording end time, a recording mode (standard, high vividness) and the like. The input timer recording information is managed by the timer recording unit 12. At the recording start time, the timer recording unit 12 extracts a target program using the TV tuner unit 41 based on the timer recording information, and records the program into the HDD 44 or the disk drive 45.

For example, in the case of digital broadcasting, program information is supplied to the information recording/reproducing device from a broadcasting station side. The program information includes information indicating channels, time zones, and contents of broadcasted programs. That is, the contents of a recording object program (type of the program) can be distinguished from the program information provided from the broadcasting station side, the channel number included in the timer recording information input by a user, the recording start time, and the recording end time. For example, it can be judged from the program information whether the recording object program is a drama program, a music program or the like. When the broadcasting is not digital, the contents of the program of the recording object cannot be distinguished. Therefore, the type of the program of the recording object may be input as the timer recording information by the user. Soundless period detection and division information setting described later are performed in accordance with the type of the program.

Next, the setting of the chapter will be described. For example, the timer recording unit 12 acquires a target program via the TV tuner unit 41 based on the timer recording information. In this case, the soundless period detection unit 13 detects a soundless period from the audio signal of the target program based on a soundless period detection condition. Furthermore, the division information setting unit 14 instructs the setting of the division information with respect to a predetermined position during the detected soundless period based on a division information setting condition. Accordingly, the formatter unit 35 sets the division information in the predetermined position of the soundless period, and the program to be recorded is formatted into a program which can be managed in a plurality of chapters based on the division information. The formatted program is recorded by the HDD 44 or the disk drive 45.

Next, the soundless period detection condition will be described. The soundless period detection unit 13 holds a predetermined soundless period detection condition. The soundless period detection condition is, for example, soundless time width information. The soundless period detection unit 13 detects a soundless period of M seconds or more as the soundless period.

Time width information M is a value arbitrarily settable by the user. For example, when the program is a drama program, M=one second is set. In a music program, M=two seconds is settable. In the drama program, for example, it is a purpose to detect a boundary between scenes in the program. When M=less than one second is set, a large number of boundaries are detected in addition to a desired boundary. For example, even a slight soundless period between conversations in the same scene in the drama is detected as a chapter boundary. Therefore, in the drama, the setting of M=less than one second is inappropriate.

On the other hand, it is a purpose of detect a boundary between pieces of music in the music program. In this case, when a value larger than M=two seconds is set, any desired boundary cannot be detected. Therefore, the value larger than M=two seconds is inappropriate in the case of the music program. The time width information M can be changed in accordance with the type of the program, that is, the above-described program information, and user instruction.

Subsequently, the division information setting condition will be described. The division information is information indicating a breakpoint between the chapter and the next chapter, and the skip reproduction is possible, for example, using a plurality of pieces of division information. When the user presses a forward skip button (not shown) of the key input unit 46 during the reproduction, the reproduction can be started from the next chapter. When the user presses a backward skip button (not shown), the reproduction can be started from an immediately previous chapter.

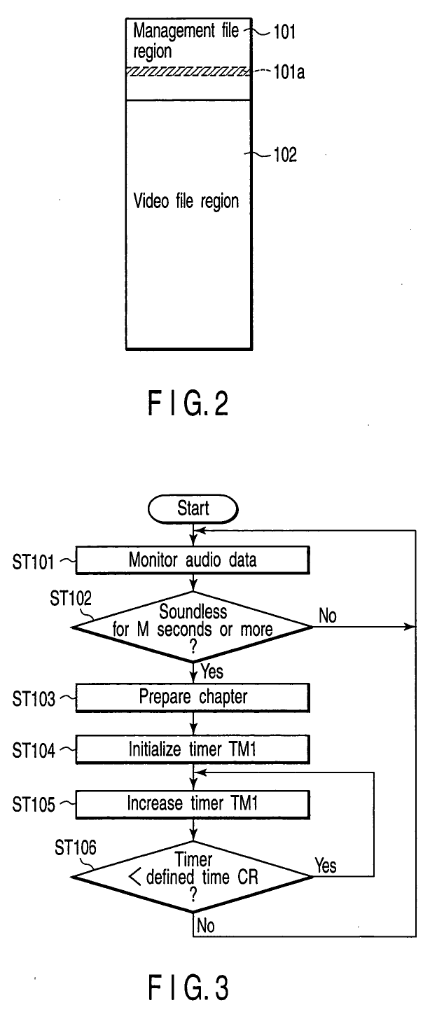

As shown in FIG. 2, data on the hard disk or the optical disk is divided into two regions: a management file region 101; and a video file region 102. Video and audio data of each program are stored in the video file region 102, and information for managing the program, such as a storage position of a program stored in the video file region 102 on the disk, information amount, and reproduction order, are recorded in the management file region 101. The division information is information indicating a breakpoint between the chapters, and is recorded, for example, in a division information table 101a in the management file region 101. The division information is recorded as the storage position of a video frame corresponding to a boundary portion between the chapters on the disk in the division information table 101a. That is, the recorded program is managed as the chapter which differs before/after the division information. A reduced image of a video frame corresponding to the boundary portion between the chapters may be recorded as a thumbnail image in the management file region 101. In this case, when the video frame corresponding to the boundary portion between the chapters is a first video frame of the rear chapter in two chapters contacting the boundary, the user can start the reproduction, for example, from the desired chapter referring to the thumbnail image displayed in a TV monitor.

The division information setting unit 14 holds the division information setting condition. The division information setting condition is a condition concerning the soundless period in which the division information is set. The division information is set concerning the soundless period which satisfies the condition. The division information setting condition can be arbitrarily changed by the user via the key input unit 46. This changing process is performed by the MPU unit 10.

When the broadcasted program is recorded, a boundary between a main portion and a commercial portion is detected as the boundary between the chapters. In general, the soundless period exists in the boundary between the main portion and the commercial portion, and the division information of the chapter is set with respect to the soundless period. However, when the division information is set with respect to all soundless periods, and when a plurality of commercial portions are continuously inserted in the broadcasted program, the division information is set between the commercial portions. In this case, user operation unfavorably becomes intricate, for example, in the skip reproduction.

This division information setting condition includes the following three setting conditions.

[Division Information Setting Condition 1]

When a soundless period is detected to set division information, and the soundless period is detected after elapse of a defined time, the division information is set to the detected soundless period. That is, the division information is set with respect to the desired soundless period, and for the subsequent defined time, the division information is not set even of the soundless period is detected.

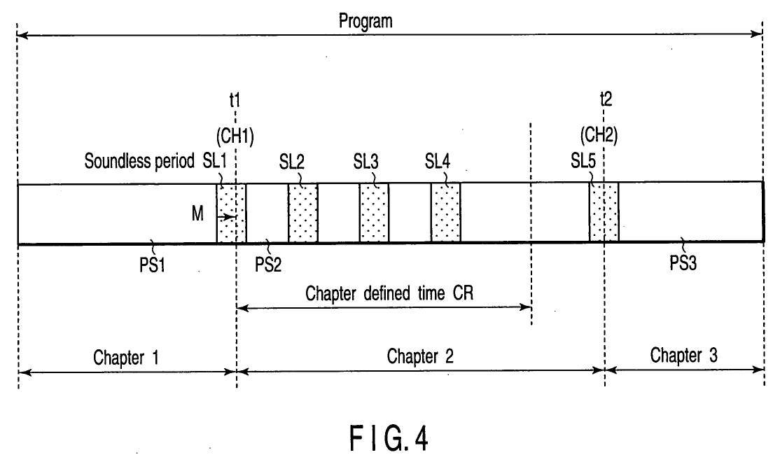

FIG. 3 is a flowchart showing a division information setting operation based on a division information setting condition 1, and FIG. 4 is a timing chart of the operation.

The soundless period detection unit 13 monitors audio data input into the audio encoding unit 33, and detects a soundless period of M seconds or more (ST101, ST102). When the soundless period of M seconds or more is detected as in time t1 of FIG. 4, the division information setting unit 14 instructs the formatter unit 35 to prepare a chapter. As shown in FIG. 2, the formatter unit 35 records position information of a video frame corresponding to the detected soundless period in the division information table 101a in the management file region 101 (ST104).

Therefore, as shown in FIG. 4, the recording of a certain program starts, position information of a video frame corresponding to a first detected soundless period SL1 is recorded as division information CH1, and a chapter 1 is prepared. As the video frame corresponding to the soundless period SL1, a position or the like of a video frame positioned in the soundless period SL1, a video frame positioned in time t1 when the soundless period is detected, a video frame positioned in a center of the soundless period SL1, or a video frame first appearing in a sound period PS2 subsequent to the soundless period SL1 is selected. The first recorded video of the sound period PS1 is, for example, a video representing the program to be recorded, or a title video in many cases.

As in step ST104, the division information setting unit 14 initializes a timer TM1 for measuring the defined time into “0”. Here, the defined time is regarded as a chapter defined time CR. After the initialization, the contents of the timer TM1 increase (ST105), and the division information setting unit 14 judges whether or not the contents of the timer TM1 are smaller than the defined time CR (ST106). When the chapter defined time CR elapses (No in ST106), the flow shifts to the step ST101 to monitor audio data, and the next soundless period is detected as in the step ST102.

Therefore, as shown in FIG. 4, after the first soundless period SL1 is detected, any division information is not set with respect to soundless periods SL2 to SL4 appearing in the chapter defined time CR. After the elapse of the chapter defined time CR, division information CH2 is recorded in a first detected soundless period SL5. As the division information CH2, as described above, the position of a video frame positioned in the soundless period SL5, a video frame positioned in the center of the soundless period SL5, or a video frame first appearing in a sound period PS3 subsequent to the soundless period SL5 is selected.

The above-described chapter defined time CR is, for example, information (default) of initial setting, and is held by the division information setting unit 14 beforehand. The setting condition can be freely changed by the user. That is, the division information setting condition can be freely changed via the key input unit 46. Furthermore, in the program recording of a time zone (e.g., daytime having many commercial portions, the chapter defined time CR is set to be longer than a time zone (e.g., nighttime) having a comparatively few commercial portions. Accordingly, even when a large number of commercial portions continuously appear, or a commercial time is long, it is possible to set the division information in a desired position.

[Division Information Setting Condition 2]

When a soundless period, and the subsequent sound period not more than a predetermined time are repeated from a time when division information is inserted until a defined time elapses, division information is inserted with respect to a last soundless period in the defined time. That is, when the division information is set with respect to the detected soundless period, and the sound period not more than the predetermined time is repeated for the subsequent chapter defined time, the division information is set to the last soundless period in the chapter defined time.

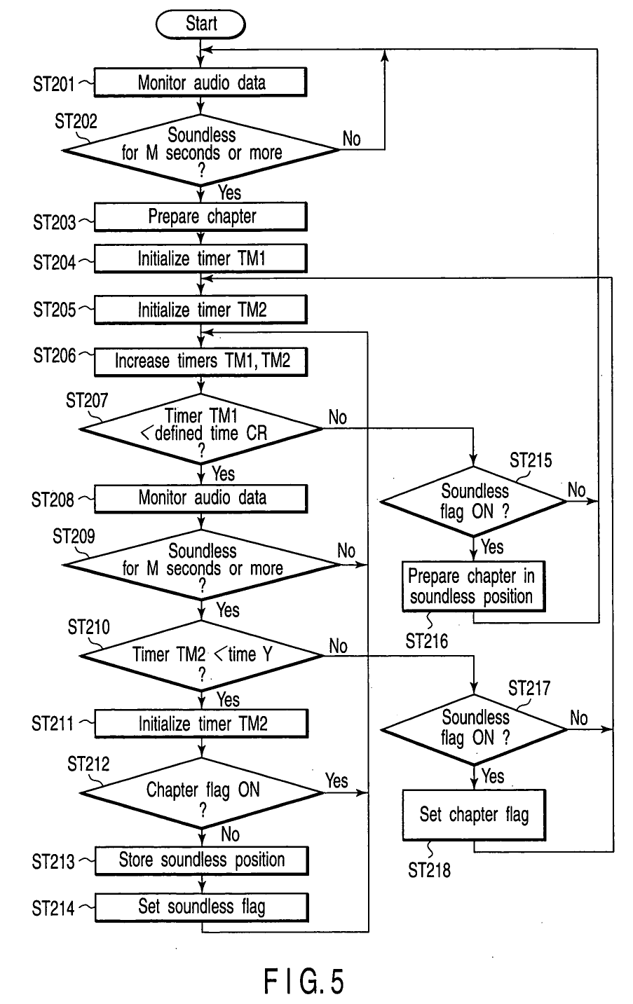

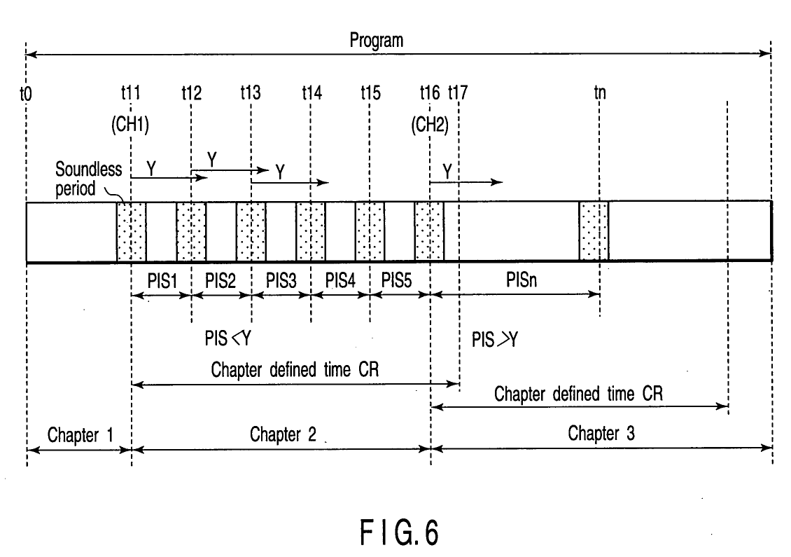

FIG. 5 is a flowchart showing the division information setting operation based on a division information setting condition 2, and FIG. 6 is a timing chart of the operation.

The soundless period detection unit 13 monitors audio data input into the audio encoding unit 33, and detects a soundless period of M seconds or more (ST201, ST202). When the soundless period of M seconds or more is detected, the division information setting unit 14 instructs the formatter unit 35 to prepare a chapter. As described above, the formatter unit 35 records position information of a video frame corresponding to the detected soundless period into the division information table 101a in the management file region 101 (ST203).

As in step ST204, the division information setting unit 14 initializes a timer TM1 for measuring a chapter defined time CR into “0”, and initializes a timer TM2 for measuring a sound time in the period into “0”. That is, in the example shown in FIG. 6, the timers TM1, TM2 are initialized into “0” at time t1. The sound time in the period indicates a continuing time of a sound period existing between the soundless period and the next soundless period in the period of the defined time CR. As shown in FIG. 6, the sound time in the period is substantially equal to a time (e.g., PIS1) from a time (e.g., t1) when the soundless period is detected until a time (e.g., t2) when the next soundless period is detected. Therefore, in the present embodiment, each of times PIS1, PIS2, PIS3 . . . is assumed as the sound time in the period.

After the initialization as in steps ST204, ST205, the contents of the timers TM1, TM2 increase (ST206), and the division information setting unit 14 judges whether or not the contents of the timer TM1 are smaller than the defined time CR (ST207). When the defined time CR does not elapse (Yes in ST207), the soundless period detection unit 13 monitors the audio data input into the audio encoding unit 33, and detects a soundless period of M seconds or more (ST208, ST209).

When the soundless period is detected, the division information setting unit 14 judges whether or not the contents of the timer TM2 are smaller than a predetermined time Y (ST210). When the contents are smaller (Yes), the timer TM2 is initialized into “0” (ST211). Furthermore, the division information setting unit 14 judges whether or not a chapter flag 14b (described later) in the predetermined time Y is ON. In this case, since the flag is OFF (No), a soundless position detected in the step ST209 is stored (ST213), and a soundless flag 14a in the predetermined time Y is set to “1” (ON). In the example shown in FIG. 6, during the chapter defined time CR, any of sound times PIS1 to PIS5 in the period is smaller than the predetermined time Y, the timer TM2 is initialized in times t12, t13, t14, t15, the process of the steps ST206 to ST214 is repeated, and storing (updating) of the soundless position is repeated as in step ST213.

In the step ST207, when the contents of the timer TM1 are not less than the chapter defined time CR as in time t17 (No), the division information setting unit 14 judges whether or not the soundless flag 14a of the predetermined time Y is ON (ST215). Here, since the soundless flag 14a is set to be ON in the step ST214 (Yes), the division information setting unit 14 instructs the formatter unit 35 to prepare the chapter. As shown in FIG. 2, the formatter unit 35 records the position of the video frame corresponding to the soundless position stored in the step ST213 as division information CH2 into the division information table 101a in the management file region 101 (ST216).

The predetermined time Y for evaluating the above-described sound time in the period is, for example, information (default) of initial setting, and held by the division information setting unit 14 beforehand. The predetermined time Y can be freely changed via the key input unit 46 by the user as in the chapter defined time CR. This changing process is performed by the MPU unit 10. When the predetermined time Y is set to be comparatively short, and when a long-time commercial portion is inserted into the program, the division information is sometimes et in the commercial portion or between the commercial portions except a boundary between the commercial portion and the main portion. However, when the predetermined time Y is set to be short in this manner in the music program, the division information can be set before/after each music in the main portion.

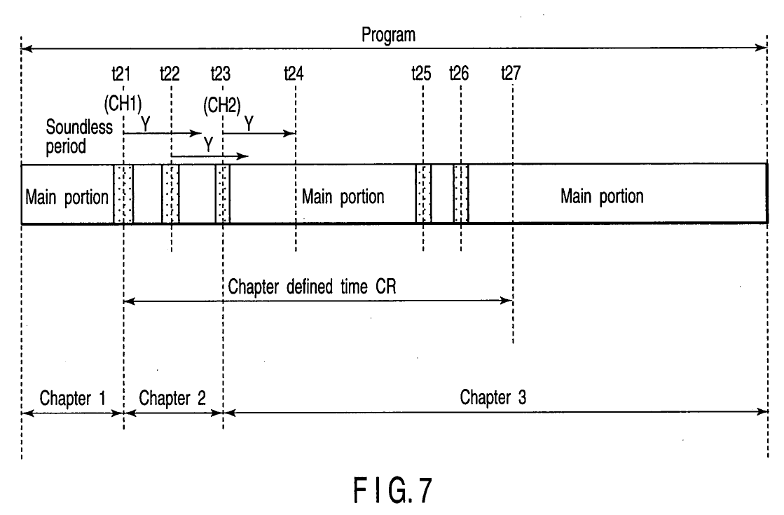

FIG. 7 shows another program having a constitution of the program to be recorded, which is different from that of FIG. 6. The division information setting operation based on the division information setting condition 2 will be described hereinafter with respect to the program shown in FIG. 7 with reference to FIG. 5. In this example, the chapter defined time CR is set, for example, to about ten minutes, and a short main portion is inserted between the commercial portions as in times t23 to t25. Since the operation in an initial recording stage in the present embodiment is similar to that of the above-described embodiment, description thereof is omitted.

After initializing the timers TM1, TM2 at time t21, the soundless period is detected in the predetermined time Y as in time t22. Then, as described above, the division information setting unit 14 stores the soundless position, and sets the soundless flag 14a in the predetermined time Y to “1” (ST206 to ST214). The steps ST213, ST214 are similarly executed even in time t23. In this case, the soundless position is updated.

When the contents of the timer TM2 are not less than the predetermined time Y as in time t24 (No in ST210), the division information setting unit 14 judges whether or not the soundless flag 14a is ON (ST217). In this case, since the soundless flag 14a is set to “1” in the step ST214, the flow advances to step ST218, and the division information setting unit 14 sets the chapter flag 14b in the predetermined time Y to “1”, and initializes the timer TM2 (ST205).

When the soundless period is detected as in the time t25, the division information setting unit 14 judges whether or not the chapter flag 14b is ON as in the step ST212. In this case, since the chapter flag 14b is set in the step ST218, the flow shifts to the step ST206. When the soundless period is similarly detected even in time t26 (Yes in the step ST209), the flow goes through the steps ST210, ST211, ST212, and thereafter shifts to the step ST206. Therefore, when the sound time is not less than the predetermined time Y as in the time t24 in the period of the chapter defined time CR, the soundless position is not stored in the subsequent times t25 and t26 (steps ST213, ST214 are not executed).

When the contents of the timer TM1 are not less than the chapter defined time CR as in time t27 (No in ST207), the division information setting unit 14 judges whether or not the soundless flag 14a is ON (ST215). In this case, since the soundless flag 14a is set in the step ST214 (time t23), the division information setting unit 14 instructs the formatter unit 35 to prepare the chapter. The formatter unit 35 records the soundless position stored in the step ST213 as the division information CH2 in the division information table 101a (ST216).

[Division Information Setting Condition 3]

In a case where a sound form is different between sound periods before and after a detected soundless period from a time when division information is inserted until elapse of a defined time CR, the division information is inserted in the soundless period. That is, the division information is set with respect to the soundless period only in a case where a sound broadcasting system changes via the soundless period in the chapter defined time CR. In programs to be broadcasted, a commercial portion is stereo, and a main portion is monaural in many cases. In this case, the present embodiment is effective.

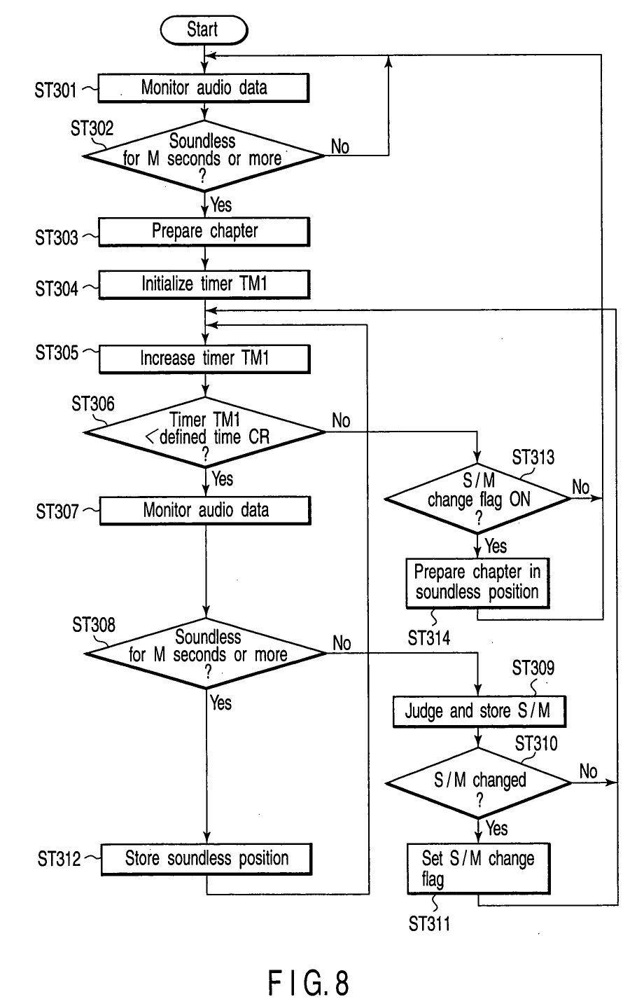

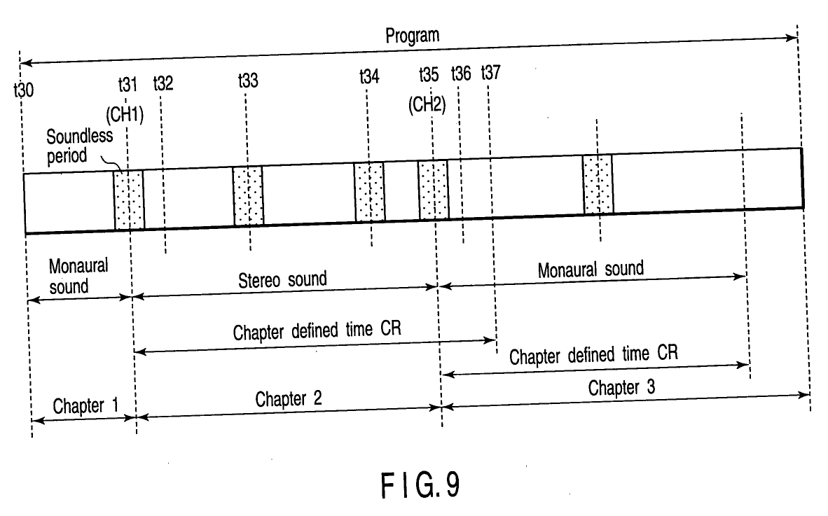

FIG. 8 is a flowchart showing the division information setting operation based on a division information setting condition 3, and FIG. 9 is a timing chart of the operation.

The soundless period detection unit 13 monitors audio data input into the audio encoding unit 33, and detects a soundless period of M seconds or more (ST301, ST302). When the soundless period of M seconds or more is detected as in time t31, the division information setting unit 14 instructs the formatter unit 35 to prepare a chapter. As described above, the formatter unit 35 records position information of a video frame corresponding to the detected soundless period into the division information table 101a in the management file region 101 (ST303).

As in step ST304, the division information setting unit 14 initializes a timer TM1 for measuring a chapter defined time CR into “0” (ST304). After the initialization, the contents of the timer TM1 increase (ST305), and the division information setting unit 14 judges whether or not the contents of the timer TM1 are smaller than the defined time CR (ST306). When the contents of the timer TM1 are smaller than the defined time CR (Yes in ST306), the soundless period detection unit 13 monitors audio data input into the audio encoding unit 33 (ST307), and detects the soundless period of M seconds or more (ST308).

When there is not a soundless period of M seconds or more as in time t32 (No in the step ST308), the division information setting unit 14 judges the sound form of the audio data, that is, a stereo/monaural (S/M) form, and stores a judgment result (ST309). The division information setting unit 14 checks whether or not there has been a change in the stereo/monaural form (ST310). In this case, since there is not any change (No), the flow shifts to the step ST305.

When there is a soundless period of M seconds or more as in time t33 (Yes in ST308), the division information setting unit 14 stores the position of the soundless period detected in the step ST308 (ST312), and returns to the step ST305. The position of the soundless period is similarly stored (updated) in times t34, t35.

When there is a change in the stereo/monaural form after the soundless period as in time t36 (Yes in ST310), the division information setting unit 14 sets a stereo/monaural change flag 14c to “1” (ST311).

When the contents of the timer TM1 are not less than the chapter defined time CR as in time t37 (No in the step ST306), the division information setting unit 14 judges whether or not the stereo/monaural change flag 14c is set to be ON. In the case of ON (Yes), the formatter unit 35 is instructed to prepare the chapter in the soundless position stored in the step ST312. The formatter unit 35 records the soundless position into the division information table 101a in accordance with the instruction (ST314).

As described above, the stereo/monaural change of the audio data is detected in the chapter defined time CR. Therefore, the main portion can be appropriately separated from the commercial portion.

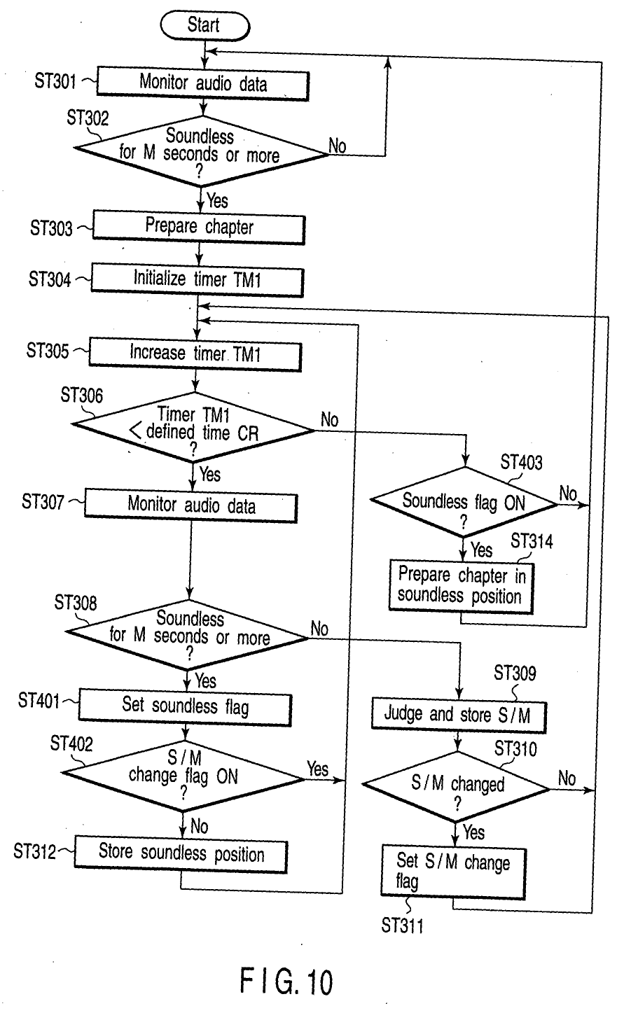

FIG. 10 shows a modification of the embodiment shown in FIG. 9. In this modification, steps ST401, ST402 are added, and the step ST313 of FIG. 9 is changed to a step ST403.

When the soundless period of M seconds or more is detected in the step ST308, the division information setting unit 14 sets the soundless flag 14a to “1” (ON) (ST401). When it is judged in step ST402 that the S/M change flag 14c is set (Yes), the flow shifts to the step ST305. That is, the position of the soundless period detected in the step ST308 is not stored.

As a result, when the soundless period is detected in the chapter defined time CR, and there is a stereo/monaural change before/after the soundless period, the division information is set to the soundless period as in the embodiment of FIG. 9. Furthermore, when the soundless period is detected in the chapter defined time CR, and there is not any stereo/monaural change before/after the soundless period, the division information is set to the last soundless period in the chapter defined time CR as in the embodiment of FIG. 6. Therefore, the main portion can be further appropriately separated from the commercial portion.

Next, another embodiment of the present invention will be described.

Any division information may not be inserted in a program, for example, in a case where the program (video data) is copied at a high speed. In this case, the division information setting unit 14 records division information in a division information table of a management file region in response to user instruction. The copied program is not reproduced during the recording of the division information.

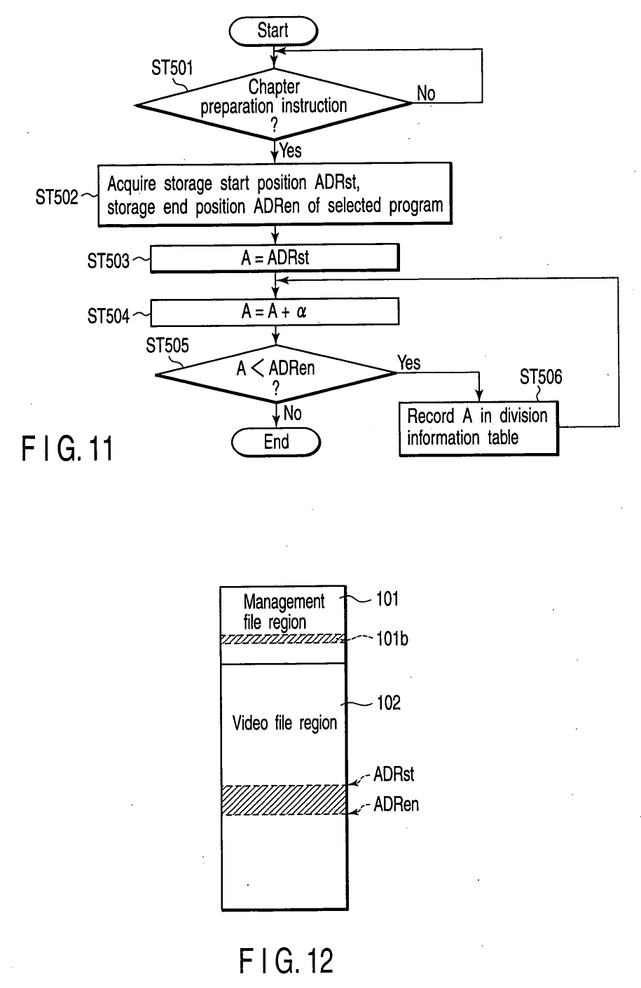

FIG. 11 is a flowchart showing an operation of the present embodiment.

A user displays a list of programs recorded in the HDD 44 or the DVD 100, for example, in a screen of a TV monitor using the key input unit 46, selects one program, and instructs the present recording device to prepare a chapter. Here, as shown in a data file constitution diagram of FIG. 12, it is assumed that the selected program is recorded in a region from a position ADRst of the video file region 102 of the HDD 44 or the DVD 100 to ADRen. Recorded position information of the program is described in the management file region 101, when the program is recorded in the video file region.

On receiving a chapter preparation instruction (Yes in ST501), the division information setting unit 14 acquires a storage start position ADRst and a storage end position ADRen of the selected program, referring to the management file region (ST502).

In step ST503, the storage start position ADRst is substituted into a variable A, and a is added to the variable A (here, ADRst) in step ST504. This a is information corresponding to a predetermined video reproduction time to be skipped, such as five or ten minutes, and is information changeable by the user. In the step ST504, the division information setting unit 14 judges whether or not the variable A to which α has been added is smaller than the storage end position ADRen. When the variable A is small, the division information setting unit 14 records the variable A into a division information table 101b secured for the program selected by the user (ST506). The process of the steps ST504 to ST506 is repeated until the variable A is not less than the storage end position ADRen. As a result, the division information is prepared in the division information table 101b every predetermined video reproduction time. Therefore, the division information can be set later in an arbitrary time with respect to the already recorded program.

As described above, according to various embodiments of the present invention, The division information is appropriately set in the recorded program, and the recorded program is managed by a plurality of chapters. Therefore, the user can skip/reproduce the recorded program utilizing the division information instantly, without setting any division information while reproducing the recorded program. Since the division information is set to a boundary between a portion of the contents of a drama program and the commercial portion, or a boundary between pieces of music in a music program, the video skips to an appropriate position during the skip reproduction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. A recording device comprising:
a recording unit configured to record a target program in a recording medium;
a detection unit configured to detect a soundless period of the program, when the program is recorded in the recording medium by the recording unit;
a first setting unit configured to set division information in the soundless period detected by the detection unit in the program recorded in the recording medium;
a judgment unit configured to judge whether or not a defined time has elapsed from a time when the first setting unit has set the division information; and
a second setting unit configured to set the division information in the soundless period detected by the detection unit in the program recorded in the recording medium after the elapse of the defined time.

2. The recording device according to claim 1, further comprising:
a user interface configured to input a user instruction; and
a variable unit configured to vary the defined time in accordance with the user instruction input via the user interface.

3. A recording device comprising:
a recording unit configured to record a target program in a recording medium;
a detection unit configured to detect a soundless period of the program, when the program is recorded by the recording unit;
a first setting unit configured to set division information in the soundless period detected by the detection unit in the program recorded in the recording medium;
a judgment unit configured to judge whether or not a defined time has elapsed from a time when the first setting unit has set the division information; and
a second setting unit configured to set the division information in a last soundless period in the defined time in the program recorded in the recording medium in a case where the soundless period and a sound period subsequent to the soundless period and not more than a predetermined time are repeated during the defined time.

4. The recording device according to claim 3, further comprising:
a user interface configured to input a user instruction; and
a variable unit configured to vary the predetermined time in accordance with the user instruction input via the user interface.

5. A recording device comprising:
a recording unit configured to record a target program in a recording medium;
a detection unit configured to detect a soundless period of the program, when the program is recorded by the recording unit;
a first setting unit configured to set division information in the soundless period in the program recorded in the recording medium;
a judgment unit configured to judge whether or not a defined time has elapsed from a time when the division information has been set; and
a second setting unit configured to set the division information in the soundless period in the program recorded in the recording medium in a case where a sound form is different between sound periods before and after the soundless period detected by the detection unit during the defined time.

6. A recording method comprising:
recording a target program into a recording medium;
detecting a soundless period of the program, when the program is recorded;
setting division information in the soundless period in the program recorded in the recording medium;
judging whether or not a defined time has elapsed from a time when the division information has been set; and
setting the division information in the soundless period in the program recorded in the recording medium after the elapse of the defined time.
